(19) United States
(12) Patent Application Publication
(10) Pub. No.: US 2024/0081190 A1
(43) Pub. Date: Mar. 14, 2024

(54) WAX-COATED JUTE FABRIC AND METHOD

(71) Applicant: KING ABDULLAH UNIVERSITY OF SCIENCE AND TECHNOLOGY, Thuwal (SA)

(72) Inventors: Himanshu MISHRA, Thuwal (SA); Kennedy ODOKONYERO, Thuwal (SA)

(21) Appl. No.: 18/273,898

(22) PCT Filed: Jan. 24, 2022
(86) PCT No.: PCT/IB2022/050592

§ 371 Date: Jul. 24, 2023

Related U.S. Application Data
(60) Provisional application No. 63/141,104, filed on Jan. 25, 2021.

(51) Int. Cl. A01F 25/14; D06M 11/38; D06M 13/02; D06M 13/188

(52) U.S. Cl. CPC A01F 25/14; D06M 11/38; D06M 13/02; D06M 13/188; D06M 2101/06

(57) ABSTRACT

A treated fabric for grain storage includes plural jute fibers woven together to form a fabric, the plural jute fibers having a smooth external surface; first rough regions formed into the external surface of a jute fiber of the plural jute fibers; second rough regions formed into the external surface of the jute fiber; and a paraffin wax layer located over the external surface of the jute fiber, the first rough regions, and the second rough regions. The first rough regions originate from a different substance than the second rough regions, and the second rough regions are deeper than the first rough regions.

### CROSS-REFERENCE TO RELATED APPLICATIONS

This application claims priority to U.S. Provisional Patent Application No. 63/141,104, filed on Jan. 25, 2021, entitled “WAX-COATED JUTE FABRICS AND THEIR APPLICATIONS,” the disclosure of which is incorporated herein by reference in its entirety.

### BACKGROUND

### Technical Field

Embodiments of the subject matter disclosed herein generally relate to a coated jute fabric that is hydrophobic, and more particularly, to a wax-coated jute bag that is used for storing seeds and preventing humidity from entering the bag.

### Discussion of the Background

Grain crops such as cereals, oil seeds, and pulses form the basis of global food security. Approximately 25-33% of the total grains produced annually are lost between harvest and consumption through “post-harvest losses” (PHL). They entail quantitative and qualitative food loss within the interconnected postharvest chains, from harvest, storage, processing, marketing, to final consumption. Of all these loses, up to 50-60% of cereals alone are lost during storage in developing countries due to poor storage infrastructure, and slower adoption of modern technologies. These PHL can be in form of spoilage, seed viability loss, grain depletion, and nutritional loss as a result of biotic (e.g., insects, rodents, fungi) and abiotic factors (e.g., temperature, air-moisture/humidity) that negatively affect the stored grain crops. Fungal infection and mycotoxin contamination cause 25-40% PHL during seed/grain storage.

To prevent these losses, a highly efficient food supply chain, from the farms to the table, need to be developed. In the context of seed deterioration, Harrington's rule states that for each 1% increase in the seed moisture content (SMC), the storage life of the seed reduces by half. This empirical rule underscores the significance of insulating stored grains from water in its liquid and vapor forms. Typically, seeds are dried to about SMC 13% before storage; as the SMC reaches about 16%, the Harrington's rule becomes breached and seed deterioration is accelerated. This rule emphasizes the importance of the type of storage structure, packaging material, duration, and relative humidity (RH), because storage bags that absorb moisture facilitate its diffusion to the dry grains, thereby, increasing the SMC.

To keep the SMC under check, the concept of “dry chain,” akin to “cold chain” for perishable products, has been put forth, wherein grains are dried upon harvest followed by the use of moisture-proof packaging until consumption. Furthermore, to combat humid environments, researchers have developed moisture- and oxygen-proof hermetic storage systems such as GrainPro Superbags™ and Purdue Improved Crop Storage (PICS) bags. However, together with the current plastic-based polyethylene bags universally used in packaging in both developed and developing countries, these polypropylene bags are vulnerable to puncturing from sharp objects and rodents; their costs and non-biodegradability also present disposal challenges and serious environmental problems. Therefore, low-cost solutions for preventing PHLs are still needed and there is a worldwide movement to move away from plastic-based materials and return to biodegradable based bags.

In developing countries, such as the Indian subcontinent and sub-Saharan Africa, most farmers use common jute bags (CJBs) for storing grains due to their low-cost, mechanical durability, and traditional usage over time. These bags are stacked in traditional storage structures or outdoor stockpiles covered with tarpaulin. However, jute is a water-loving (hydrophilic) material owing to its chemical components: cellulose (˜60%), hemicellulose (˜20), lignin (˜10%), pectin, and water-soluble substances. This renders the CJBs vulnerable to PHL due to the inadvertent exposure of grains to moisture through humid air or rainfall, which conventional storage systems interact with. Inevitably, water accumulation and/or vapor transport through the porous CJBs elevates the SMC, causes fungal infections, and seed deterioration, which eventually affects overall seed quality. As a result, in its current form, the CJB does not satisfy the desired requirements for enhancing the shelf life of stored grains under hot and humid conditions over the medium and long-term storage period.

Thus, there is a need for an improved jute fiber based storage bag that prevents moisture from entering inside the bag, which is fully recyclable and biodegradable and remains cost effective and affordable for developing countries.

### BRIEF SUMMARY OF THE INVENTION

According to an embodiment, there is a treated fabric for grain storage, and the treated fabric includes plural jute fibers woven together to form a fabric, the plural jute fibers having a smooth external surface, first rough regions formed into the external surface of a jute fiber of the plural jute fibers, second rough regions formed into the external surface of the jute fiber, and a paraffin wax layer located over the external surface of the jute fiber, the first rough regions, and the second rough regions. The first rough regions originate from a different substance than the second rough regions, and the second rough regions are deeper than the first rough regions.

According to another embodiment, there is a method for making a treated fabric for grain storage, and the method includes providing plural jute fibers, immersing the plural jute fibers into a first alkali solution to obtain weak alkali processed plural jute fibers, immersing the weak alkali processed plural jute fibers into a second alkali solution, which is different from the first alkali solution, to obtain strong alkali processed plural jute fibers, and coating the strong alkali processed plural jute fibers with paraffin wax to obtain the treated fabric.

According to still another embodiment, there is a mulch for protecting the soil, and the mulch includes plural jute fibers woven together to form a fabric, first rough regions formed into an external surface of a jute fiber of the plural jute fibers, second rough regions formed into the external surface of the jute fiber, and a paraffin wax layer located over the external surface of the jute fiber, the first rough regions, and the second rough regions. The first rough regions originate from a different substance than the second rough regions and the second rough regions are deeper than the first rough regions.

### BRIEF DESCRIPTION OF THE DRAWINGS

For a more complete understanding of the present invention, reference is now made to the following descriptions taken in conjunction with the accompanying drawings, in which:

FIG. 1 is a flow chart of a method for manufacturing a treated fabric based on jute fibers and paraffin wax;

FIG. 2 schematically illustrates the steps of the method for making the treated fabric of FIG. 1;

FIGS. 3A to 3E schematically illustrates the various chemical substances that are used with the jute fibers for making them to have an increased roughness and for obtaining the treated fabric;

FIG. 4A shows the total moisture absorbed by the treated fabric and stored grains versus storage time for various fabrics;

FIG. 4B shows the post-storage seed moisture content versus the ambient relative humidity for the various fabrics of FIG. 4A;

FIG. 5 illustrates the seed germination percentage versus the ambient relative humidity for the treated fabric and a control jute bag;

FIG. 6A illustrates an experimental set up for testing mulch qualities as the mulch is made based on the treated fabric; and

FIG. 6B illustrates the moisture lost by the soil when protected with the treated fabric and other untreated or partially treated fabrics.

### DETAILED DESCRIPTION OF THE INVENTION

The following description of the embodiments refers to the accompanying drawings. The same reference numbers in different drawings identify the same or similar elements. The following detailed description does not limit the invention. Instead, the scope of the invention is defined by the appended claims. The following embodiments are discussed, for simplicity, with regard to a storage bag made of jute fibers. However, the embodiments to be discussed next are not limited to jute fibers, but may be applied to other natural fibers that are using for storing grains.

Reference throughout the specification to “one embodiment” or “an embodiment” means that a particular feature, structure or characteristic described in connection with an embodiment is included in at least one embodiment of the subject matter disclosed. Thus, the appearance of the phrases “in one embodiment” or “in an embodiment” in various places throughout the specification is not necessarily referring to the same embodiment. Further, the particular features, structures or characteristics may be combined in any suitable manner in one or more embodiments.

According to an embodiment, the jute fibers are processed to impart surface modifications for achieving water-repellent properties, which are desirable for reducing moisture absorption and PHL during storage. To remedy the challenge of jute's hydrophilicity, according to one embodiment, the inventors have developed an engineering solution to render them water repellent (hydrophobic) through a chemical treatment process exploiting alkali and paraffin wax. Thus, the processed jute fibers aim at mitigating post-harvest losses during seed storage arising from the absorption of moisture by jute bags containing stored grains in the likely events of precipitation or increase of the air-borne relative humidity (RH). The technology discussed herein enhances the shelf-life of the stored grains and seeds under ≤75% RH conditions, and also facilitates increased resilience under ultrahigh (98%) RH conditions.

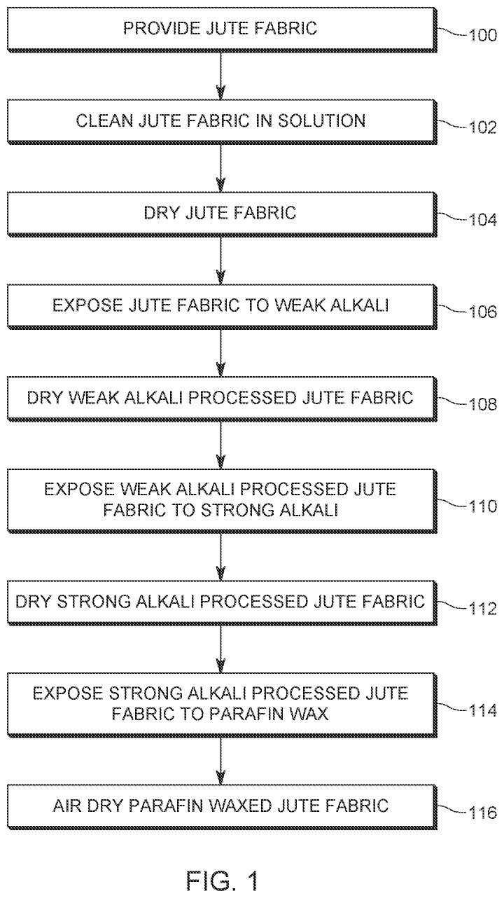

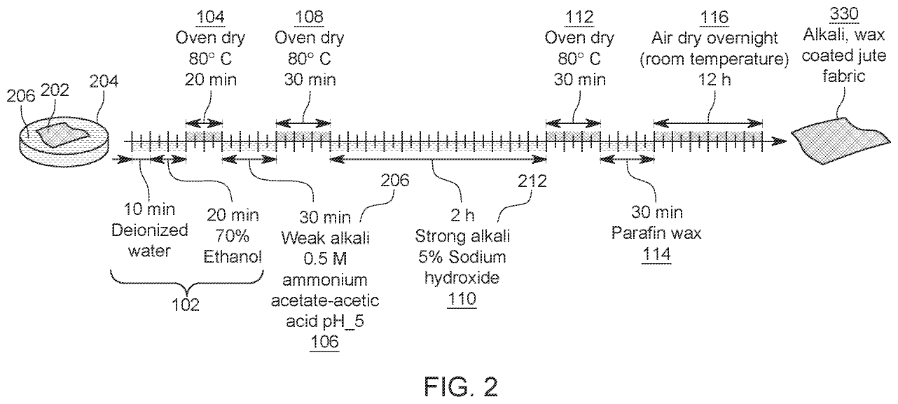

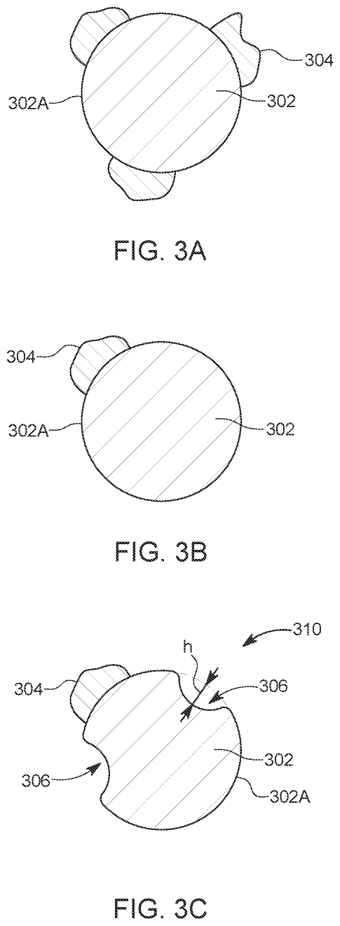

According to an embodiment, which is illustrated in FIGS. 1 and 2, a method for processing an existing commercial jute bag or jute fabric or even jute fibers, for preventing or reducing an amount of moisture entering the bag or passing through the fabric, starts in step 100, by providing the jute bag 202. Note that instead of providing the jute bag, it is possible to provide the jute fabric or the jute fibers and then to make the jute bag from the processed jute fabric or fibers. For these reasons, the terms “jute bag” and “jute fabric” are interchangeably used herein. Note that a jute fiber, from which the jute bag or jute fabric are made, is a long, soft, shiny bast fiber that can be spun into coarse, strong threads and it is produced from flowering plants of the genus Corchorus (C. capsularis and C. olitorius spp.). In cross-section, a jute fiber 302 is shown in FIG. 3A, being substantially circular and having various impurities 304 attached to its exterior surface 302A.

Because of these impurities, the jute fabric 202 is preferably cleaned prior to applying the waxing treatment. Thus, in step 102, the jute fabric is first cleaned in water, for example, for 10 minutes, followed by an ethanol bath, for example, 70% ethanol for 20 minutes, for removing most of the impurities 304. For this step, the jute fabric 202 may be placed in a container 204 that holds the desired cleaning solution 206. After this step, a cross-section of the jute fiber is illustrated in FIG. 3B, with less or no impurities 304 attached to its external surface 302A. Note that the cleaning step 102 may include only the sub-step of water cleaning, only the sub-step of ethanol cleaning, or both of these two sub-steps. The times mentioned above are just an example, other times, shorter or longer, may be used. Also note that the cleaning step is optional. Further note that an exterior surface 302A of the fiber 302 is substantially smooth.

Next, the cleaned jute fabric 202 is oven dried in step 104 in an oven, for example, for 20 minutes at 80° C. After the drying step, the jute fabric 202 is brought back into a container, for example, container 204, and exposed in step 106 to a weak alkali 206. The weak alkali 206 may be, for example, an 0.5 M ammonium acetate (NH₄CH₃CO₂) solution that was adjusted to pH 5 using 1.0% glacial acetic acid. The weak alkali is defined herein to be a base having a pK_{b} factor between 4 and 5. The pK_{b} is the negative base-10 logarithm of the base dissociation constant (K_{b}) of a solution. It is used to determine the strength of a base or alkaline solution and has the formula pK_{b}=−log₁₀ K_{b}. The lower the pK_{b} value, the stronger the base.

The weak alkali roughens up the smooth surface 302A of the fiber 302, forming first rough regions 306, thus forming the weak alkali processed jute fiber 310, as illustrated in FIG. 3C. A “rough region” is defined herein as being a region in the fiber in which the hemicelluloses and other fibers are dissolved and removed from the surface of the fiber, leaving behind a trench or groove 306, which makes the external surface of the fiber to be become rougher. The weak alkali step 106 also causes the swelling and constriction of the pores in the jute fiber. In this embodiment, the step 106 lasts for about 30 minutes. Note that other weak alkali substances may be used and the exposure time may be changed upwards or downwards. The weak alkali processed jute fabric 310 is again oven dried, in step 108, for example, for 30 minutes at 80° C. Other times and temperatures may be used or this step may be entirely omitted. A depth (measured from the substantially smooth, original exterior surface of the fiber) of the removed hemicelluloses and other fibers is h for this step.

The weak alkali processed jute fabric 310 is now immersed in a strong alkali 212 in step 110 for about 2 h. The strong alkali 212 may be, for example, 5% (m/v) sodium hydroxide (NaOH) solution. The strong alkali solution has a pK_{b} of between −1 and −2. During this step, the strong alkali 212 further removes the hemicelluloses and other fibers, making deeper grooves 312 (the second rough region) into the external surface of the fiber 302 as illustrated in FIG. 3D, which results in a strong alkali processed jute fabric 320. A depth H of the grooves 312 is larger than the depth h of the grooves 306. If the material in an existing groove 306 is further dissolved by the strong alkali 212, the new groove 312 becomes the deepest groove, i.e., the second rough region. However, if the strong alkali 212 dissolves the material at the smoot surface of the jute fiber 302, it will form a less deep groove 313, which becomes the third rough region. It is also possible that some of the existing grooves 306 are not further enlarged by the strong alkali 212, which then remain the first rough regions. Thus, grooves 312 are the deepest, grooves 306 are the shallowest, and grooves 313 are in between. The presence of these grooves makes the fibers to be rough. Note that although the first rough regions 306, the second rough regions 312, and the third rough regions 313 might look identical, they are provided by two different chemical substances, during two different processing steps.

The strong alkali processed jute fabric 320 shown in FIG. 3D may now be washed in step 112, in ionized water, for example, for 30 min at 80° C. Next, the strong alkali processed jute fabric 320 is immersed in a paraffin wax 314 dissolved in hexane in step 114 for coating the fibers 302 with a paraffin wax layer 316, as illustrated in FIG. 3E. The alkali paraffin wax coats the jute fabric 330 shown in FIG. 3E so that at least one fiber 302 is fully coated with the paraffin wax layer 316. However, in one embodiment, the paraffin wax only partially covers the jute fiber 312. Note that the paraffin wax 314 may also coat the remaining impurities 304, the first rough regions 306, the second rough regions 312, and the third rough regions 313. However, due to the rough surface of the fiber 302, one or more of the grooves 306, 312, and 313 may trap air 318 under the paraffin wax layer 316, as schematically shown in FIG. 3E. The jute fabric 330 may be turned around while in the paraffin wax 314 to facilitate uniform coating. This step may last for about 30 minutes. After this step, the alkali paraffin wax coated jute fabric 330 is taken out of paraffin wax 314 and left for about 12 h to air dry in step 116, for example, at room temperature. The alkali paraffin wax coated jute fabric 330 is then used to manufacture bags or baskets or other items (e.g., mulch). Other substances may be used instead of the paraffin wax to make the jute fabric hydrophilic, for example, beeswax. However, the paraffin is preferred for its low price, abundance, and lack of negative environment effects.

As alkali-treated jute fabrics were coated with paraffin wax, the combination of surface roughness of the fibers and the hydrophobicity of the wax produced robust water repellency. The intrinsic hydrophobicity of the paraffin wax is characterized by the apparent contact angles of water droplets on smooth wax-coated surfaces: θₒ≈105°. When a rough surface is coated with a hydrophobic coating, the resulting water-repellency is enhanced by the entrapment of air 318 inside the surface asperities, which also prevent the penetration of water into the microtexture.

The alkali paraffin wax coated jute fabric 330 has been tested under various conditions for establishing its advantages relative to the CJB. The treated fabric 330 was characterized in terms of its wetting characteristics. During a first test, deionized water droplets with food coloring were sprayed on the fabric and a contact angle goniometer was used to characterize the wettability of the fabric surfaces. During this test, the treated fabric 330 and the CJBs were also exposed to simulated rainfall for ˜1 min: they were placed at an angle of ˜30° and the simulated raindrops were applied by releasing water droplets (˜2 mL) from a syringe placed ˜5 cm above the bags. As the alkali-treated fabrics 330 were coated with wax, the combination of surface roughness and wax's hydrophobicity yielded robust water repellence. This is because of the intrinsic hydrophobicity of paraffin wax, characterized by apparent contact angles of water droplets on smooth wax-coated surfaces, θₒ≈105°. When a rough surface is coated with a hydrophobic coating, the resulting water-repellence is enhanced due to the robust entrapment of air inside the surface asperities, which also prevent the penetration of water into the microtexture. Furthermore, when the treated fabric 330 and the CJBs were exposed to simulated rainfall, the CJBs got wet by the impacting water droplets and accumulated, whereas the raindrops impacting the treated fabric 330 simply rolled-off, preempting water accumulation. Based on these results, the inventors determined that the treated fabric 330 offers superior protection to stored grains against humid air in comparison to the CJBs.

In terms of grain storage, the potential of the treated fabric 330 at enhancing the shelf life and viability of stored wheat grains (e.g., Triticum aestivum) in environments with relative humidity in the range of 55 to 98% was investigated for two months and compared with that of the CJBs. The seed moisture content of the wheat prior to storage was 7.1%, which was well within Harrington's safe zone (6-16%). Wheat grains were stored in bags made of the treated fabric 330, and CJBs (as controls) at 21.6±0.5° C. under three different air humidity levels of ˜55% RH, 75% RH and 98% RH. The air humidity level was controlled in confined spaces by equilibrating it with supersaturated salt solutions of Ca(NO₃)_{2.4}H₂O, NaCl, and K₂SO₄. During the two months-long seed storage experiment, the inventors examined the moisture absorption and the mold growth on the jute bags and the stored grains every three days.

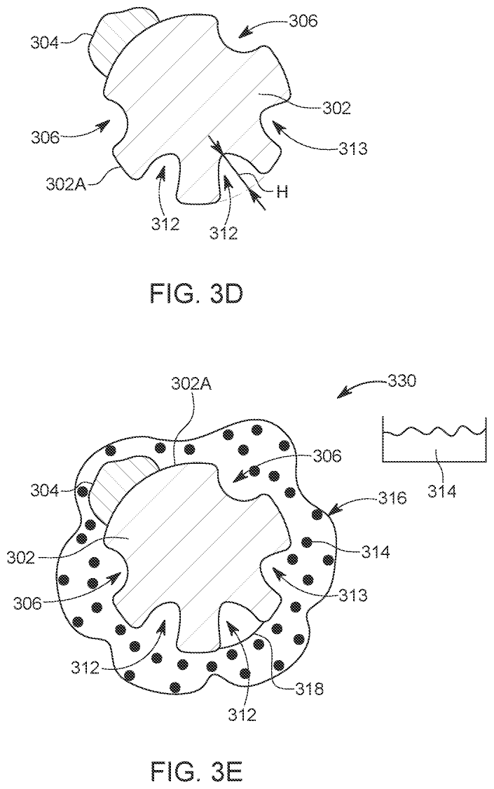

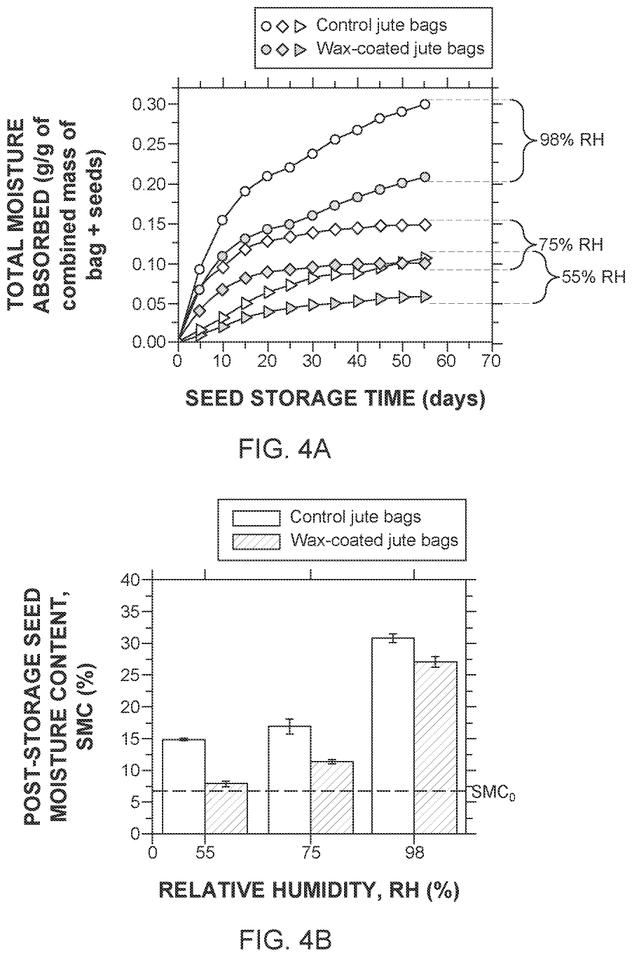

For the 55% RH case, the total moisture absorbed by the treated fabric 330 and the stored grain was 46% lower than that of the CJB and grain system, as illustrated in FIG. 4A. The SMC of the grains stored in the treated fabric 330 increased from 7.1 to 7.5%, whereas the SMC of the grains in the CJBs increased from 7.1 to 14.9%, as illustrated in FIG. 4B. Notably, the CJBs absorbed 12-times more moisture than that absorbed by the treated fabric 330. Thus, the CJBs acted as reservoirs for moisture for the stored grains. Next, for the 75% RH treatment, the total moisture absorbed by the treated fabric and grain system was 32% lower than the controls. The SMC of the grains stored in the treated fabric bags increased from 7.1 to 11%, whereas the SMC of the grains in the CJBs increased to 17%. Lastly, for the 98% RH treatment, the total moisture absorbed by the treated fabric and grain system was 45% lower than the controls. The SMC of the grains stored in the treated fabric increased to 26%, whereas the controls increased to 32%. These findings, which are illustrated in FIGS. 4A and 4B, demonstrate that the treated fabric bags provide superior protection to stored grains than the CJBs, at least for a humidity less than 75% RH.

In regard to the fungal infestation, due to their water repellency, the treated fabric bags absorbed significantly lesser water from the air than the CJBs, during storage under different RH conditions. For the 55% RH treatment, the inventors did not observe signs of fungal mold on bags or grains in the treated fabric bags or CJBs. For the 75% RH treatment, the treated fabric bags and their stored grains did not exhibit mold growth, whereas the CJBs and their stored grains showed dampness and fungal growth towards the end of the study. Tiny droplets of condensed water appeared onto the treated fabric bags towards the end of the study, as expected for hydrophobic surfaces, but the droplets did not imbibe into the bag's surface. For the 98% RH treatment, both the treated fabric bags and CJBs and their stored grains exhibited dampness and fungal growth. Condensed water droplets appeared on the treated fabric bags after 2 weeks, and as they grew larger, many rolled off the surface. Fungal proliferation on the grains stored inside the treated fabric bags was less prominent than that on the grains stored inside the CJBs.

To investigate the full potential of the treated fabric bags as a reliable seed storage medium, the inventors studied the germination of the stored grains using the formula,

$$S G = \frac{Number of germinated seeds}{Total number of seeds sown} \times 10.$$

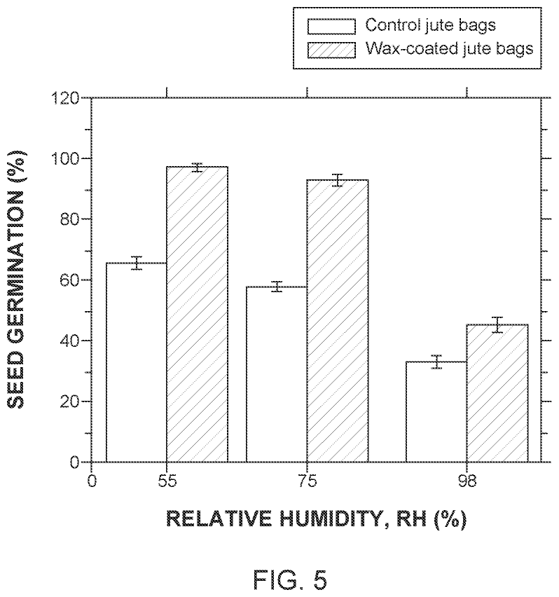

Overall, the inventors found that wheat germination was significantly higher for the grains stored in the treated fabric bags than those stored in the CJBs. At 55%, 75%, and 98% RH, the percentage enhancements in the germination capacity were 32%, 35%, and 12%, respectively, as illustrated in FIG. 5.

The treated fabric 330 discussed above is not only more efficient in preserving and protecting the grain crops, but it is also easily disposable and/or recyclable. The treated fabric 330 is a good candidate for soil conservation and amelioration. In this regard, a large effort in the past has mainly focused on the application of straw and plastic mulches for improving soil moisture retention, water use efficiency and crop yields. However, the use of straw and plastic mulches in arid areas is constrained by limited biomass residues, and the environmental concerns arising from plastics in conjunction with their capacity to increase soil temperature, which negatively impact plant growth. A study conducted on the efficiency of soil mulching materials in reducing excessive water loss in the arid/semi-arid, silt-clay soil of Pakistan recorded a maximum irrigation water saving of 45% under polyethylene sheet mulches followed by 30% under rice straw. In another study, strip intercropping combined with straw mulching in wheat strips and two-year plastic mulching in maize strips significantly decreased soil evaporation and the evaporation/evapotranspiration ratio by 9.0-17.3% and 8.6-17.5%, respectively compared to the conventional intercropping treatment with no mulching.

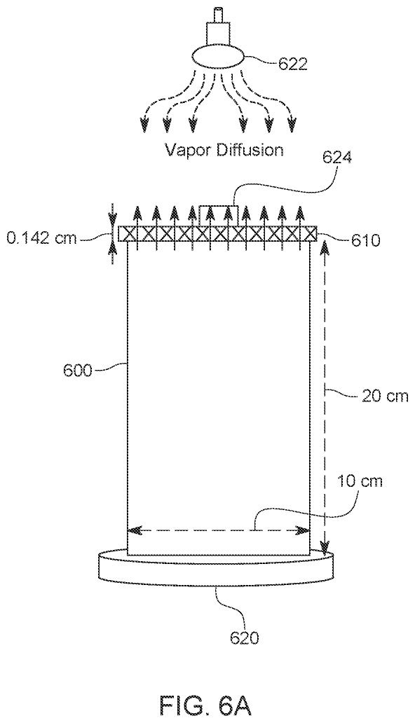

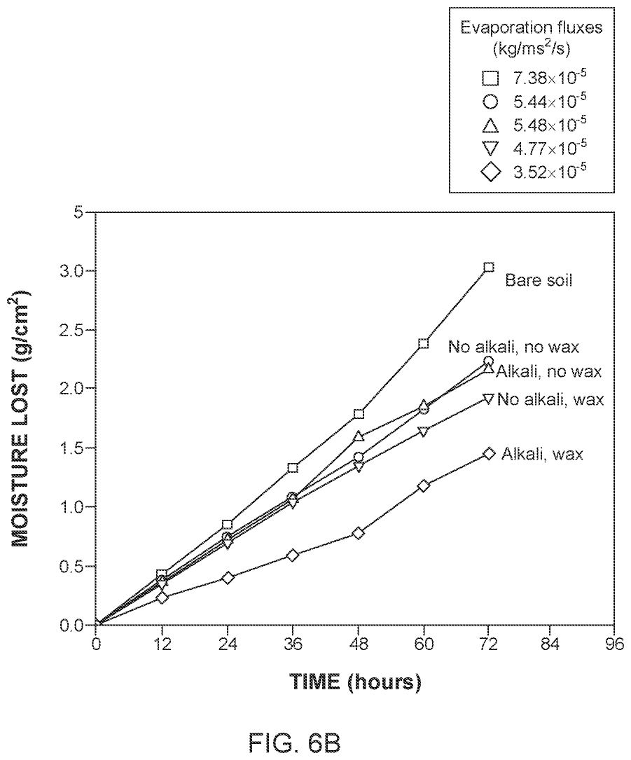

For similar treatment and characterization protocols, the inventors investigated the mulching potential of the treated fabric 330 by conducting mass transfer (evaporation) experiments in Polyvinyl chloride (PVC) tubes or columns 600 of 10 cm (diameter) and 20 cm (height), closed at one end, as shown in FIG. 6A. The inventors measured the soil evaporative water loss considering moisture movement by capillarity through a soil column toward the dry soil layer on top having either the wax-coated jute mulch 330, control jute mulch or bare soil. The columns 600 were filled with 1.44 kg of sandy soil and watered to field capacity, as illustrated in FIG. 6A. The soil used was a common desert sandy soil from Western Saudi Arabia having an initial moisture content of 0.26 kg water per kg of soil. Jute mulches 610, made from the treated fabric 330, were carefully placed on top of the soil columns and tied using threads and rubber bands so that it makes good contact with the soil. In one embodiment, the treated fabric 330 has a thickness of about 0.7 cm. In another embodiment, the thickness of the treated fabric 330 is between 0.1 and 1 cm. A surface density of the treated fabric 330 is between 300 and 800 g/m². The initial weight of each soil column was determined with a mass balance 620 and samples were completely randomized in an evaporation set-up integrated with a high temperature lamp (160 Watt) 622 and sensors 624 that recorded the moisture in terms of RH and temperature changes over the soil surface. The inventors determined the water loss from soil gravimetrically by subtracting the final weight from initial weight of the soil column after every 12 hrs for 72 hrs.

In the wax-coated jute mulch 610, the total evaporative water loss was reduced by 52% compared to that in bare soil, as illustrated in FIG. 6B. Note that this figure also illustrates the performance of a partially treated jute fabric, i.e., only alkali and no wax, or no alkali and only wax. This means that the method discussed above with regard to FIGS. 1 and 2 may be modified to include only step 106, or only step 108, or both steps 106 and 108 but not step 114, or only step 114 and not steps 106 or 108. Also, it is possible to combine step 114 with only one of the steps 106 and 108. Meanwhile, the control jute mulch accounted for 26.4% reduction in evaporation compared to the bare soil. These results demonstrate that using common (untreated) jute fabrics as mulches could also provide significant benefits in terms of soil moisture retention compared with leaving the soil bare. However, applying hydrophobic wax coating onto the common jute mulches would double this benefit, thus enhancing soil water availability for increasing crop growth and yields.

Recent studies on jute have shown that nonwoven agro-textile jute mulches exhibit maximum efficiency in soil moisture conservation in the range of 300-800 g/m² thicknesses. Application of jute mulches at such range of thickness has been reported to have superior effects over rice straw, polyethylene mulch and bare soil in terms of soil moisture retention under certain conditions. However, the results discussed above suggest that using wax-coated jute mulches could stand at a comparative advantage to the existing plastic mulches in terms of irrigation water saving, without necessarily increasing the jute mulch thicknesses. Wax-coated jute mulch would not pose disposal and other environmental challenges like plastic mulch since it is biodegradable. In addition, it would not cause increase in the soil temperature because of its porous nature, given that not all pores on the surface get clogged by the wax coating. Thus, the mulch can still maintain aeration within plant roots and the entire soil environment unlike plastic mulch.

Therefore, the above discussed treated fabric is low cost, eco-friendly, and easy to manufacture due to the rich availability of jute fabrics, alkalis, and paraffin wax. The treatment process discussed above with regard to FIGS. 1 and 2 renders this technology scalable and has the potential to be applicable to a wide range of applications. Compared to plastics, this does not require landfilling; jute fabrics are extremely durable and easy to retreat and reuse; wax-coating thickness can be tuned based on the applications.

The technology discussed above can find applications in various sectors, for example, bags for seed storage (discussed above), mulches for irrigated agriculture, engineering and construction, and transport. More specifically, the treated fabric 330 can be used as mulches to reduce evaporation from soil and could therefore provide a green alternative to plastic mulching for improving irrigation efficiency and crop production in dry land agriculture. This will not only improve the irrigation water-use efficiency, but also reduce weeds that usually cause significant yield losses in agriculture.

Regarding the engineering and construction field, the treated fabric 330 can be manufactured as geotextile jute mats that can be used in land restoration to prevent flooding and associated landslides in landscapes with difficult terrains. When spread as a landscape mat, the water-repellent jute fabrics would reduce the area of contact between rainwater and the soil, thus preventing not only surface erosion but also the massive landslides that accompany heavy downpour in most regions.

The engineering and construction sector could also use this novel treated fabric 330 for construction of low-cost ecological housing and silos for grain storage. Construction of houses and seed storage silos could involve filling the hydrophobic bags with soil and piling them neatly into decent ecological structures, thus utilizing just a limited amount of cement. This would reduce the huge financial and environmental costs associated with cement production (energy, water, etc.).

The novel treated fabric 330 can also be used as a damp-proofing course in building constructions. On account of its varied thicknesses (200-700 g/m²) and hydrophobicity, this modified jute material could be a better alternative to the current 300 μm polyethylene sheet used as damp-proofing membrane to resist moisture uptake through building walls.

In the transport field, the natural bast fibers such as flax, jute and hemp have been reported as being the best alternative fibers for automobile interior because their ductile and specific stiffness are an advantage during side impacts. For instance, vehicle and ships interior require water-repellent surfaces, for which this treated fabric could be upgraded to serve as furnishing fabrics in such automobiles, in addition to floor carpets.

The disclosed embodiments provide a treated fabric based on jute that can be used for grain storage and exhibits water barrier properties, while being recyclable and bio-degradable. It should be understood that this description is not intended to limit the invention. On the contrary, the embodiments are intended to cover alternatives, modifications and equivalents, which are included in the spirit and scope of the invention as defined by the appended claims. Further, in the detailed description of the embodiments, numerous specific details are set forth in order to provide a comprehensive understanding of the claimed invention. However, one skilled in the art would understand that various embodiments may be practiced without such specific details.

Although the features and elements of the present embodiments are described in the embodiments in particular combinations, each feature or element can be used alone without the other features and elements of the embodiments or in various combinations with or without other features and elements disclosed herein.

This written description uses examples of the subject matter disclosed to enable any person skilled in the art to practice the same, including making and using any devices or systems and performing any incorporated methods. The patentable scope of the subject matter is defined by the claims, and may include other examples that occur to those skilled in the art. Such other examples are intended to be within the scope of the claims.

1. A treated fabric for grain storage, the treated fabric comprising:
plural jute fibers woven together to form a fabric, the plural jute fibers having a smooth external surface;
first rough regions formed into the external surface of a jute fiber of the plural jute fibers;
second rough regions formed into the external surface of the jute fiber; and
a paraffin wax layer located over the external surface of the jute fiber, the first rough regions, and the second rough regions,
wherein the first rough regions originate from a different substance than the second rough regions, and the second rough regions are deeper than the first rough regions.

2. The treated fabric of claim 1, wherein the paraffin wax layer fully encapsulates the external surface of the jute fiber.

3. The treated fabric of claim 1, wherein a thickness of the treated fabric is between 0.1 and 1 cm.

4. The treated fabric of claim 1, further comprising:
third rough regions formed into the external surface of the jute fiber, the third rough regions having a depth larger than the first rough regions and shorter than the second rough regions.

5. The treated fabric of claim 1, wherein the first rough regions originate from an ammonium acetate solution.

6. The treated fabric of claim 5, wherein the second rough regions originate from a sodium hydroxide solution.

7. A method for making a treated fabric for grain storage, the method comprising:
providing plural jute fibers;
immersing the plural jute fibers into a first alkali solution to obtain weak alkali processed plural jute fibers;
immersing the weak alkali processed plural jute fibers into a second alkali solution, which is different from the first alkali solution, to obtain strong alkali processed plural jute fibers; and
coating the strong alkali processed plural jute fibers with paraffin wax to obtain the treated fabric.

8. The method of claim 7, wherein prior to the first immersing step, the plural jute fibers are cleaned with deionized water first, and ethanol second, to remove impurities.

9. The method of claim 8, wherein the cleaned plural jute fibers are dried in an over prior to the first immersing step.

10. The method of claim 7, wherein the weak alkali processed plural jute fibers are dried in an oven prior to the second immersing step.

11. The method of claim 7, wherein the strong alkali processed plural jute fibers are dried in an oven prior to the coating step.

12. The method of claim 7, wherein the weak alkali processed plural jute fibers include first rough regions and the strong alkali processed plural jute fibers include additional second rough regions, wherein the first rough regions originate from a different substance than the second rough regions.

13. The method of claim 12, wherein the first rough regions originate from an ammonium acetate solution.

14. The method of claim 13, wherein the second rough regions originate from a sodium hydroxide solution.

15. The method of claim 7, wherein a paraffin wax layer fully encapsulates an external surface of a jute fiber of the plural jute fibers.

16. The method of claim 7, wherein a thickness of the treated fabric is between 0.1 and 1 cm.

17. The method of claim 15, wherein the jute fiber includes third rough regions, the third rough regions having a depth larger than the first rough regions and shorter than the second rough regions.

18. The method of claim 7, further comprising:
making bags with the treated fabric; and
storing grains in the bags.

19. A mulch for protecting soil, the mulch comprising:
plural jute fibers woven together to form a fabric;
first rough regions formed into an external surface of a jute fiber of the plural jute fibers;
second rough regions formed into the external surface of the jute fiber; and
a paraffin wax layer located over the external surface of the jute fiber, the first rough regions, and the second rough regions,
wherein the first rough regions originate from a different substance than the second rough regions and the second rough regions are deeper than the first rough regions.

20. The mulch of claim 19, wherein the paraffin wax layer fully encapsulates the external surface of the jute fiber.
